(19) United States
(12) Patent Application Publication
(10) Pub. No.: US 2017/0016581 A1
(43) Pub. Date: Jan. 19, 2017

(54) Omni-directional Lighting LED Bulb Lamp

(71) Applicant: DongGuan Bright LED Ellectronics Ltd., Dong Guan City (CN)

(72) Inventors: TSUNG JEN LIAW, Dong Guan City (CN); TSUNG HSING CHEN, Dong Guan City (CN)

(21) Appl. No.: 14/987,162

(22) Filed: Jan. 4, 2016

(30) Foreign Application Priority Data
Jul. 15, 2015 (CN) 201510414892.4

(51) Int. Cl. F21K 99/00; F21V 23/00

(52) U.S. Cl. CPC F21K 9/1355; F21K 9/56; F21V 23/003

(57) ABSTRACT

The present invention discloses an omni-directional lighting LED bulb lamp, which comprises a LED module, a power-driven unit electrically connected with the LED module and a bulb intended for enclosing and sealing the LED module. The LED module comprises at least one LED lamp panel, and the positive end and negative end of the LED module are electrically connected with the power-driven unit through the conductive posts. The present invention provides a high-efficiency, high-lumen 360° omni-directional lighting LED bulb lamp which can solve the problem of residual shadows that LED filament lamps have, and therefore can serve as a main illuminator.

### BACKGROUND OF THE INVENTION

Technical Field

The present invention relates to the LED technical field, and more especially, to an omni-directional lighting LED bulb lamp.

Description of Related Art

LED filaments are also called LED heater. Existing LED light sources are incorporated with optical elements such as lens to achieve a certain illuminance and illumination area, which affects the illumination effect and reduces the virtue of energy saving inherent in LED. 360° omni-directional light-emitting LED filaments can emit light at a wide angle without lens, serving as a three-dimensional light source and providing an unprecedented lighting experience.

Conventional LED lamps emit light in a single direction, and existing LED filament lamps can provide 360° lighting. However, strip residual shadows occur among filaments, making LED filament lamps impossible to serve as a main illuminator and limiting the application of the same.

### BRIEF SUMMARY OF THE INVENTION

The present invention provides a high-efficiency, high-lumen 360° omni-directional lighting LED bulb lamp which can solve the problem of residual shadows that LED filament lamps have and therefore can serve as a main illuminator, to overcome the shortage of the prior art above.

To solve the technical problem above, the present invention adopts the following technical solution: An omni-directional lighting LED bulb lamp, comprising a LED module, a power-driven unit electrically connected with the LED module and a bulb intended for enclosing and sealing the LED module; the positive end and negative end of the LED module are electrically connected with the power-driven unit through conductive posts, the LED module comprises a first LED lamp panel and a second LED lamp panel which are disposed at an angle, and the angle between the first LED lamp panel and the second LED lamp panel faces downward.

In the technical solution above, the positive post is electrically connected with the positive ends of the first LED lamp panel and the second LED lamp panel, and the negative post is electrically connected with the negative ends of the first LED lamp panel and the second LED lamp panel, so that the first LED lamp panel is connected in parallel with the second LED lamp panel.

In the technical solution above, the positive post is electrically connected with the positive end of the first LED lamp panel, the negative end of the first LED lamp panel is electrically connected with the positive end of the second LED lamp panel and the negative post is electrically connected with the negative end of the second LED lamp panel, so that the first LED lamp panel is connected in series with the second LED lamp panel.

In the technical solution above, the power-driven unit is arranged in a lamp socket, and a glue base is provided between the socket and the bulb.

In the technical solution above, the LED lamp panel comprises substrates the front of which is provided with a number of LED chips and the back of which is provided with phosphor powders, wherein phosphor powders are provided between the substrate and the LED chips, the chips are fixed in position through glue coatings, and metal pieces are provided at either end of the substrates to serve as the positive and the negative respectively.

In the technical solution above, the metal pieces are sandwiched and fastened between the substrates at either end.

In the technical solution above, the surface of the metal pieces is coated with a reflective layer.

In the technical solution above, the bulb is filled with the mixture of inert gases including helium, argon and nitrogen.

In the technical solution above, the glue coatings on the LED chips have a height that is 1.5 to 3 times the thickness of the LED chips.

In the technical solution above, the LED lamp panel comprises two transparent substrates that cover each other, and the LED chips are arranged on the inside of one of the transparent substrates.

In the technical solution above, the LED lamp panel comprises two transparent substrates that cover each other, a number of LED chips are arranged on the inside of one of the transparent substrates, a number of LED chips are arranged on the inside of the other of the transparent substrates, and the LED chips are disposed on the two transparent substrates in such a way that they can form a staggered combination.

The present invention has the following beneficial effects: Substitution of LED filaments with LED panels will not have the problem of strip residual shadows occurring among filaments while providing 360° omni-directional lighting, making the lamp according to the present invention possible to serve as a main illuminator and enhancing the application value of LED lamps; besides, the lamp has a simple overall structure, and a less manufacturing cost and time than LED filament lamps, significantly improving the production efficiency; it can completely replace filament lamps as the main illuminator, protecting the environment; Heat in LED filament lamps are not easily dissipated due to too small spacing among the LED chips on LED filaments, which limits the application of LED filaments, while the LED lamp panels according to the present invention can dissipate heat well than ordinary LED filaments in virtue of substrates with a large area and the possibility that the spacing among the LED chips can be adjusted to provide best heat dissipation, ensuring the durability and safety of LED.

### BRIEF DESCRIPTION OF THE SEVERAL VIEWS OF THE DRAWINGS

FIG. 1 is a structural diagram of the LED lamp panel according to the present invention;

FIG. 2 is a structural diagram of the LED lamp panel shown in FIG. 1 seen from the side;

FIG. 3 is another structural diagram of the LED lamp panel according to the present invention;

FIG. 4 is still another structural diagram of the LED lamp panel according to the present invention;

FIG. 5 is an overall structural diagram of the present invention;

FIG. 6 is a structural diagram of Embodiment I according to the present invention;

FIG. 7 is a structural diagram of LED lamp panels connected in parallel in Embodiment II according to the present invention;

FIG. 8 is a structural diagram of LED lamp panels connected in series in Embodiment II according to the present invention.

In the drawings, 1. LED module; 2. power-driven unit; 3. bulb; 4. inert gas; 5. lamp socket; 6. glue base; 11. LED lamp panel; 12. first LED lamp panel; 13. second LED lamp panel; 14. positive post; 15. negative post; 16. connecting piece; 111. substrate; 112. phosphor powder; 113. glue; 114. LED chip; 115. metal piece.

### DETAILED DESCRIPTION OF THE INVENTION

The present invention will be further detailed hereinafter in combination with the drawings.

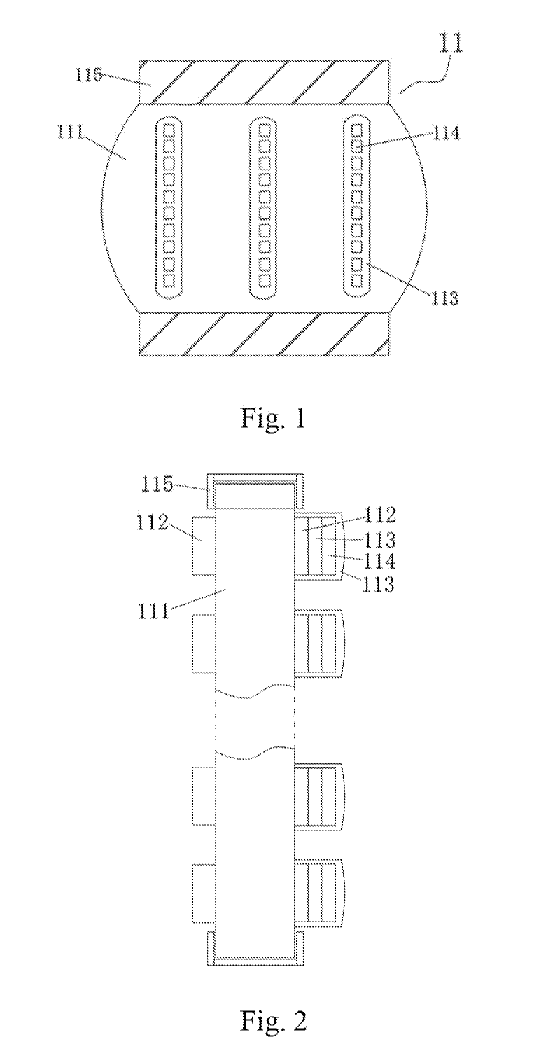

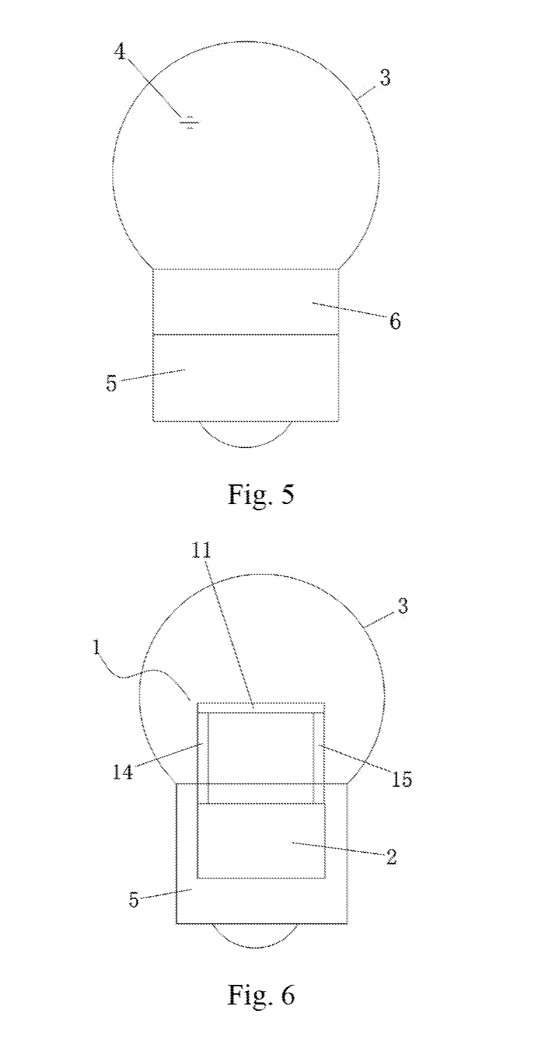

As shown in FIGS. 1, 2, 3, 4, 5, 6, 7 and 8, an omni-directional lighting LED bulb lamp, comprising a LED module 1, a power-driven unit 2 electrically connected with the LED module 1 and a bulb 3 intended for enclosing and sealing the LED module 1, the bulb 3 is filled with the mixture of inert gases 4 including helium, argon and nitrogen; the LED module 1 comprises at least one LED lamp panel 11, and the positive end and negative end of the LED module 1 are electrically connected with the power-driven unit through the conductive posts.

The LED lamp panel comprises substrates 111 the front of which is provided with a number of LED chips 114 which are disposed in a matrix, wherein the matrix may be 3*10 as shown in FIG. 1 or alternatively be 4*12, and although provision of more chips will provide high lumen, considering heat dissipation, an appropriate number of LED chips may be provided; phosphor powders 112 are provided between the substrate 111 and the LED chips 114, the back of the substrates 111 is provided with phosphor powders 112, the chips 114 are fixed in position through glue coatings 113, and the glue coatings on the LED chips 114 have a height that is 1.5 to 3 times the thickness of the LED chips 114. Metal pieces 115 are provided at either end of the substrates 111 to serve as the positive and the negative respectively, the metal pieces 115 are “sandwiched” and fastened between the substrates 111 at either end, the surface of the metal pieces 115 is coated with a reflective layer which is a silver coating which can reflect the light refracted, scattered and reflected by the bulb 3 for reuse and can also reflect the incident light from the light sources or phosphor powders 112 to increase luminance; the metal pieces 115 is “sandwiched” and fastened in the substrates 111 to increase the area contacting with the outside and help dissipate heat through the metal pieces 115. In the specification, a round sapphire substrate 111 is used together with the metal pieces 115 serving as the positive and the negative to form a shape of lantern. The glue coating 113 may be provided only on the LED chips 114 disposed into a matrix to leave spaces between the glue coatings 113 on the substrate 111, which will help the air flow with the heat and achieve effective heat dissipation; alternatively, the entire front of the substrate 111 provided with LED chips 114 is provided with the glue coatings 113. Since the substrate 111 is made of transparent sapphire, the LED lamp panels 11 can provide 360° omni-directional lighting.

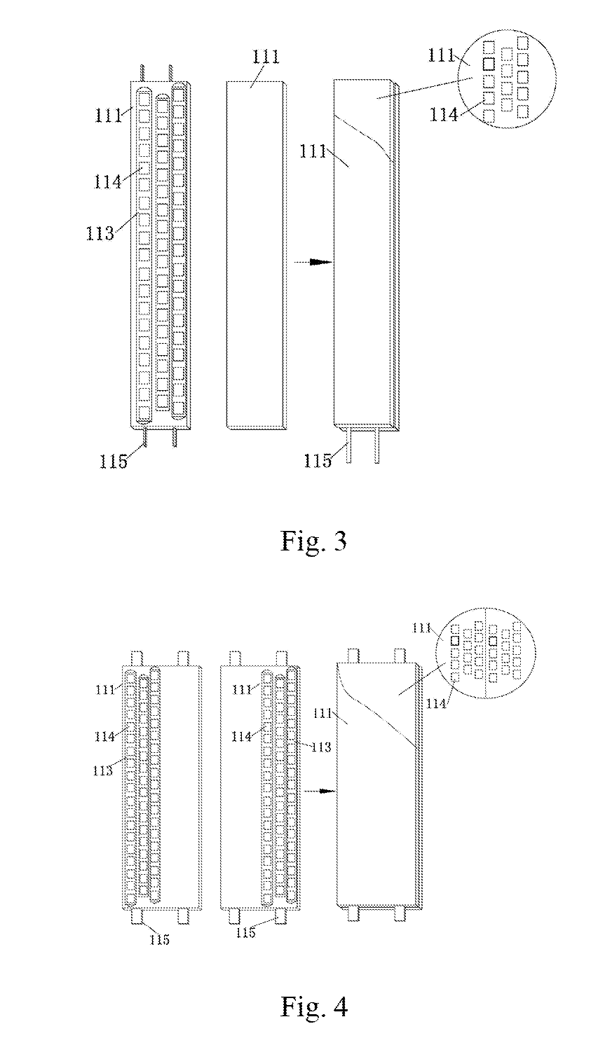

With reference to FIGS. 3 and 4, another two component units of the LED lamp panel are illustrated: The LED lamp panel 11 comprises two transparent substrates 111 that cover each other, and the LED chips 114 are arranged on the inside of one of the transparent substrates; alternatively, a number of LED chips 114 are arranged on the inside of one of the transparent substrates 111, a number of LED chips 114 are arranged on the inside of the other of the transparent substrates 111, and the LED chips are disposed on the two transparent substrates in such a way that they can form a staggered combination. The transparent substrates 111 clamp to form a LED lamp panel comprising two transparent substrates 111. Certainly, the LED chips 114 may be disposed in two ways within the LED lamp panel 11: On a single surface and on two surfaces. Certainly, a metal piece 115 is provided at either end (the upper end and the lower end) of each transparent substrate 111 of the LED lamp panel 11 to serve as the positive and the negative respectively, two wires are deposited by evaporation on the transparent substrate 111 arranged with the chips on a single side to connect the positive and the negative in such a way that the LED chips 114 are connected with the positive and the negative.

The LED lamp panel 11 is manufactured in the following steps: 1) Take PCB, ceramics, sapphire and other materials as the substrate 111 which may be in any shape; (2) sandwich and fasten metal pieces 115 between the substrates 111 at either end to serve as the positive and negative; (3) work on the substrates 111, mix phosphor powders 112 with the glue 113, and conduct die bonding; (4) roast the substrates after die bonding, and bond wires; (5) roast the substrates again after wire bonding, and conduct electrical tests; (6) dispense the glue 113 on the front after passing the electrical tests; (7) dispense the glue 113 on the back after finishing dispensing the glue 113 on the front; (8) conduct electrical tests following roasting, and the lamp panel passing the tests is a cost lamp panel.

Wherein, the power-driven unit 2 is driven by wide voltage so that the output will be constant-current one when the input is 110 or 220 AC V to ensure that the LED lamp has stable luminance and will not be affected by voltage differences.

Wherein, the power-driven unit 2 is arranged in a lamp socket 5, and a glue 113 base 6 is provided between the socket 5 and the bulb 3.

FIG. 6 illustrates Embodiment I of the present invention, wherein the LED module 1 comprises a LED lamp panel 11 the front of which faces downward. The positive end of the LED lamp panel 11 is electrically connected with the power-driven unit 2 through the positive post 14, and the negative end of the LED lamp panel 11 is electrically connected with the power-driven unit 2 through the negative post 15.

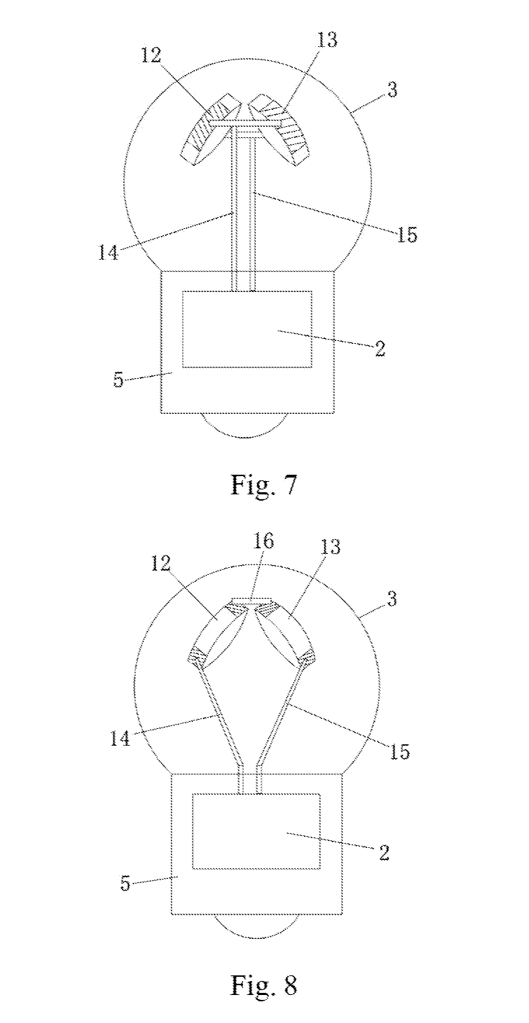

FIGS. 7 and 8 illustrate Embodiment II of the present invention, wherein the LED module 1 comprises a first LED lamp panel 12 and a second LED lamp panel 13, the fronts of two LED lamp panels 11 face outward and are disposed at an angle, the angle between the first LED lamp panel and the second LED lamp panel faces downward, and the bisector of the angle is in a vertical plane. Disposing the two LED lamp panels 11 at an angle provide brighter 360° omni-directional lighting. Alternatively, the side bonded with dies may face downward to enhance the performance of light emission. Flip chips are used so that chips need being inversely placed since no gold wire is required for gold wires will affect the light emitting of the light sources.

Wherein, as shown in FIG. 7, the positive post 14 is electrically connected with the positive ends of the first LED lamp panel 12 and the second LED lamp panel 13, and the negative post 15 is electrically connected with the negative ends of the first LED lamp panel 12 and the second LED lamp panel 13, so that the first LED lamp panel 12 is connected in parallel with the second LED lamp panel 13. Wherein, the power-driven unit 2 used for the LED lamp panel 11 is designed to be low voltage of less than 36V, which complies with safety specifications and will not cause any danger.

Wherein, as shown in FIG. 8, the positive post 14 is electrically connected with the positive end of the first LED lamp panel 12, the negative end of the first LED lamp panel 12 is electrically connected with the positive end of the second LED lamp panel 13 through a conductive connecting piece 16 and the negative post 15 is electrically connected with the negative end of the second LED lamp panel 13, so that the first LED lamp panel 12 is connected in series with the second LED lamp panel 13.

With reference to FIGS. 3, 4 and 7-8, the present invention is implemented as follows: Two transparent substrates 111 that cover each other are arranged with LED chips 114 on a single side and/or both sides to form a LED lamp panel 11 unit, multiple LED lamp panel 11 units are connected in parallel to form a LED module 1, the multiple LED lamp panels 11 connected in parallel are electrically connected with the power-driven unit 2 through the same positive post 14 and the negative post 15, and the LED lamp panels 11, the power-driven unit 2, the positive post and the negative post are enclosed in the bulb 3 to form a LED bulb lamp. Alternatively, the multiple LED lamp panels 11 may be connected in series for subsequent implementation. Besides, they may also be connected in series first and then in parallel for implementation, which will not be described herein. It should be noted that when the LED lamp panels 11 as shown in FIGS. 3 and 4 are used for implementation, the LED chips 114 selected for each LED lamp panel 11 comprises arrangement on a single side, arrangement on both sides and mixed arrangement on a single side and on both sides, and settings are selected to meet the shape of the bulb 3 and the corresponding lumen based on demands.

Certainly, the LED module 1 may also comprises more LED lamp panels 11 to for a high-lumen lamp.

The embodiments above are intended only for describing the present invention not limiting it, therefore any equivalent changes or modifications made in accordance with the method within the scope of the patent application are in the scope of the patent application of the present invention.

What is claimed is:

1. An omni-directional lighting LED bulb lamp, characterized in that, comprising a LED module, a power-driven unit electrically connected with the LED module and a bulb intended for enclosing and sealing the LED module; the positive end and negative end of the LED module are electrically connected with the power-driven unit through conductive posts, the LED module comprises a first LED lamp panel and a second LED lamp panel which are disposed at an angle, and the angle between the first LED lamp panel and the second LED lamp panel faces downward.

2. The omni-directional lighting LED bulb lamp as claimed in claim 1, characterized in that the positive post is electrically connected with the positive ends of the first LED lamp panel and the second LED lamp panel, and the negative post is electrically connected with the negative ends of the first LED lamp panel and the second LED lamp panel, so that the first LED lamp panel is connected in parallel with the second LED lamp panel.

3. The omni-directional lighting LED bulb lamp as claimed in claim 1, characterized in that the positive post is electrically connected with the positive end of the first LED lamp panel, the negative end of the first LED lamp panel is electrically connected with the positive end of the second LED lamp panel and the negative post is electrically connected with the negative end of the second LED lamp panel, so that the first LED lamp panel is connected in series with the second LED lamp panel.

4. The omni-directional lighting LED bulb lamp as claimed in claim 1, characterized in that the power-driven unit is arranged in a lamp socket, and a glue base is provided between the socket and the bulb.

5. The omni-directional lighting LED bulb lamp as claimed in claim 1, characterized in that the LED lamp panel comprises substrates the front of which is provided with a number of LED chips and the back of which is provided with phosphor powders, wherein phosphor powders are provided between the substrate and the LED chips, the chips are fixed in position through glue coatings, and metal pieces are provided at either end of the substrates to serve as the positive and the negative respectively.

6. The omni-directional lighting LED bulb lamp as claimed in claim 5, characterized in that the metal pieces are sandwiched and fastened between the substrates at either end.

7. The omni-directional lighting LED bulb lamp as claimed in claim 5, characterized in that the surface of the metal pieces is coated with a reflective layer.

8. The omni-directional lighting LED bulb lamp as claimed in claim 1, characterized in that the glue coatings on the LED chips have a height that is 1.5 to 3 times the thickness of the LED chips.

9. The omni-directional lighting LED bulb lamp as claimed in claim 5, characterized in that the LED lamp panel comprises two transparent substrates that cover each other, and the LED chips are arranged on the inside of one of the transparent substrates.

10. The omni-directional lighting LED bulb lamp as claimed in claim 5, characterized in that the LED lamp panel comprises two transparent substrates that cover each other, a number of LED chips are arranged on the inside of one of the transparent substrates, a number of LED chips are arranged on the inside of the other of the transparent substrates, and the LED chips are disposed on the two transparent substrates in such a way that they can form a staggered combination.
